(19) United States
(12) Patent Application Publication
(10) Pub. No.: US 2010/0001862 A1
(43) Pub. Date: Jan. 7, 2010

(54) Method for authenticating radio frequency identification

(76) Inventors: James Charles Wilson, Plano, TX (US); Gary Andrechak, S. San Francisco, CA (US)

Correspondence Address: MATTINGLY & MALUR, P.C., 1800 DIAGONAL ROAD, SUITE 370, ALEXANDRIA, VA, 22314, US

(21) Appl. No.: 12/216,456

(22) Filed: Jul. 3, 2008

(51) Int. Cl. G08B 13/14

(52) U.S. Cl. 340/572.1

(57) ABSTRACT

Embodiments of the invention provide a method of authenticating an item by affixing an RFID chip to the item. In one embodiment, an authentication method comprises providing an RFID chip having a unique ID readable by a device; applying the chip to an item via an adhesive; associating the ID of the chip with the item at a first point in time; and at a second point in time later than the first point in time, authenticating the item by reading the ID of the chip applied to the item and comparing with the ID associated with the item at the first point in time. The RFID chip cannot be easily removed and preferably cannot be removed without visible evidence of tampering, more preferably without destroying the RFID chip so that the ID of the RFID chip cannot be read.

### BACKGROUND OF THE INVENTION

1. Field of the Invention

The present invention relates generally to methods for authenticating articles, more specifically, inanimate objects. In particular, the present invention relates to methods for authenticating radio frequency identification (RFID) affixed to such articles.

2. Description of Related Art

Counterfeiting is a serious and growing problem. Worldwide it is estimated at over $450 billion. Authentication is the process of verifying the identity of an object or a living thing such as a person. Today, people employ an array of tactics to validate the authenticity or originality of such items. Current authenticity marking practices include the use of direct embossment of an official seal to paper documents, tamper-evident labels containing one or more security features such as holograms, two color and single color bar-codes, micro-printing, color-shifting inks, and the like. RFID and contactless smartcard tags can also be added to labels.

Current item validation labels include the following. Tamper-resistant label seals are those that tear or break apart when removal is attempted from the item to which it is originally affixed. However, such labels merely indicate that someone may have attempted to remove the label; they typically have no unique identifier (UID) or a weak scheme UID (e.g., a serial number imprinted on it) to authenticate originality or specificity. Some security labels have a bar-code imprinted on them. The number on the bar code provides an additional identifier, but barcodes are easily duplicated, like human readable printed serial numbers. Barcodes are thus weak forms of item authenticity validation. Someone could reproduce an original, valid bar code with many replicated copies. It also has the other limitations common for bar code technology, including difficulty in reading it if the bar code is dirty, dusty or smudged, and the requirement for direct line-of-sight of the barcode to the barcode reader. Hang tags are another alternative authentication seal design. These come in various forms including hardened plastic tags. Hang tags may or may not include RFID inlays as part of their security features. The problem with hang tags is that they exist separate from the items to which they are connected by cords or other filaments. Hang tags are easy to find and can usually be removed without great difficulty, and are not always tamper-evident. Furthermore, hang tags are usually too large and too cumbersome for many applications such as document authentication, especially if that document must pass through a printer or an optical scanner. Another example provides a structure of sheets having built-in electronic circuit chip for storing an ID as described in U.S. Pat. No. 7,309,019, the entire disclosure of which is incorporated herein by reference. RFID labels have primarily been used for asset management and inventory applications. Most existing RFID labels use HF or UHF frequency tags which are quite large and somewhat expensive, and they tend to be powered by read/write integrated circuits using RFID technology or smartcard ICs that contain computational power.

### BRIEF SUMMARY OF THE INVENTION

There is a great need to protect documents and other items from counterfeit activities or from tampering. A market exists for a low-cost, easy-to-use, highly secure adhesive seal or label supporting a variety of small form factors that provides a unique identifier to enable authentication. To be truly functional, it should be intuitively or mechanically easy to apply the seal or label to the item it protects, whether that item is a document or any high value item. To be truly unique it should provide a read-only identifier that cannot be replicated or overwritten. The identifier should be verifiably unique, and be easily “read” (e.g., no line-of-sight requirement with a highly accurate reading). To meet the various form factors the RFID chip and its antenna should fit inside the adhesive member such as an adhesive seal or label, and the result should be a very small label with a high degree of reliability and adaptability to various items.

Embodiments of the present invention provide a method of authenticating an article by affixing to it an RFID chip that cannot be easily removed and preferably cannot be removed without visible evidence of tampering, more preferably without destroying the RFID chip or its interconnect to an antenna material so that the ID of the RFID chip cannot be read. In some cases, removing the RFID chip will also cause visible damage to the article. The RFID chip is preferably a tiny, read-only RFID chip supporting the 2.45 GHz frequency, embedded inside an adhesive member such as a label or a seal which can be applied to any document or item that requires authentication or validation by another party at a future time and/or a different location, wherein the authentication or validation is not dependent on existing ISO standard RFID communication protocols or UID numbering schemes.

In accordance with an aspect of the present invention, an authentication method comprises providing an RFID chip having a unique ID readable by a device; applying the chip to an item via an adhesive; associating the ID of the chip with the item at a first point in time; and at a second later point in time, authenticating the item by reading the ID of the chip applied to the item and comparing with the ID associated with the item at the first point in time.

In specific embodiments, the ID of the chip is correlated with a description of the item and stored in a database separate from the item and from the RFID chip. Alternatively, the RFID chip is embedded in a label, and wherein the ID is printed on the label. In another alternative, the RFID chip is embedded in a label, an algorithm is applied to the ID of the chip to produce an algorithm result and the algorithm result is printed on the label at the first point in time, and authenticating the item includes reading the ID of the chip applied to the item, applying the algorithm to the read ID, and comparing with the algorithm result printed on the label at the first point in time.

In some embodiments, the chip is a read-only chip whose ID cannot be altered after manufacture. The chip is a semiconductor chip compatible with gamma ray energy exposure. The ID is only readable by the device. Applying the chip to the item comprises applying to the item an adhesive label with the chip embedded in the adhesive label. Removing the adhesive label from the item destroys the chip. The item is a container including a specimen or device intended to be medically sterilized. The chip is a semiconductor chip having an area of no more than about 0.4 mm² and a thickness of no more than about 0.3 mm. The method may further comprise, at or near the first point in time and prior to the second point in time, manually authenticating the item by an authenticator qualified to authenticate the item. The method may comprise, between the first point in time and the second point in time, passing the item through a chain of custody among at least three parties.

In accordance with another aspect of the present invention, an authentication method for a document comprises providing an RFID chip having a unique ID readable by a device; embedding the chip onto the document by an adhesive seal; transmitting the ID via a first path to a location different from where the embedding was processed; sending the document with the embedded chip to the location via a second path different from the first path; and authenticating the document by reading the ID of the chip embedded onto the document and comparing with the ID transmitted via the first path.

In specific embodiments, the document is a sheet of paper and the ID is transmitted via electronic mail. The ID is written into the chip during formation of the chip in a semiconductor manufacturing process. The chip is a read-only chip whose ID cannot be altered after manufacture. The chip is a semiconductor chip that is at most about 0.4 mm² in size. The chip is a semiconductor chip having a thickness of at most about 0.3 mm.

In accordance with another aspect of the present invention, an authentication method comprises providing an RFID chip having a unique ID readable by a device; affixing the chip to an article via an adhesive in such a manner that the chip cannot be removed from the article without rendering the ID of the RFID chip unreadable; correlating the ID of the chip with the article in a database; and subsequent to the correlating, authenticating the article by reading the ID of the chip applied to the article and comparing with the ID correlated with the article in the database.

In some embodiments, the chip is embedded in an adhesive member which is affixed to the article via an adhesive. Affixing the chip to the article comprises placing an adhesive layer in direct contact with the RFID chip on one side of the adhesive layer and in direct contact with the article on an opposite side of the adhesive layer. The chip is a semiconductor chip having an area of no more than about 0.4 mm² and a thickness of no more than about 0.3 mm, and the article has a thickness of no more than about 0.5 mm.

### BRIEF DESCRIPTION OF THE DRAWINGS

FIGS. 1A and 1B are side cross-sectional views of two embodiments of an adhesive label having an RFID chip.

FIG. 2 is a block diagram of an RFID chip.

FIG. 3 is a block diagram illustrating the adhesive label embedding the RFID chip/antenna in an article, communicating its ID information to a sensor in an exemplary RFID system.

FIG. 4 is a block diagram illustrating an exemplary method of implementing and using an adhesive member having an RFID chip in a system for authenticating an article in accordance with an embodiment of the present invention.

FIG. 5 is a block diagram illustrating an example of an authentication method.

FIG. 6 is a block diagram illustrating another example of an authentication method.

### DETAILED DESCRIPTION OF THE INVENTION

The present invention uses an RFID IC chip embedded in a security label or seal that is affixed to an item for protection. The RFID chip is typically a semiconductor chip and the unique numeric or alphanumeric ID is placed into the chip during formation of the chip in a semiconductor manufacturing process, i.e., “hard wired” into the chip before the chip is died out. The RFID chip is preferably a read-only chip and the ID cannot be altered after manufacture. The chip provides a unique ID for each item to which it is attached for item validation. The security label or seal is applied to the item via an adhesive. Once affixed to the item, the adhesive member preferably cannot be removed without destroying the RFID chip, or its interconnect to an external antenna, if an antenna is used, or at least producing visible evidence of tampering.

An RFID label or tag is implemented as a tiny integrated chip (IC) (hereinafter “μ-chip”) attached to an antenna. The IC stores a small amount of data, such as an ID number, and the antenna is used to communicate with a reader. For example, one particular existing Hitachi μ-chip stores 128 bits of read-only data and communicates using a frequency of 2.45 GHz. Tags can be either active, which means they contain a battery to assist in data transmission from the IC chip, or passive. In the case of passive tags an external source (e.g., the tag reader) provides the power needed for communication with the IC chip. In many applications, direct line of sight is not necessary to read a tag; tag reading can be accomplished provided the RF signal is strong enough to go between the tag and reader. With some readers and tags it is possible to read multiple tags simultaneously. RFID tags are designed to work at specific radio frequencies depending upon the physical characteristics of the antenna. Higher frequencies enable faster communication and typically larger read ranges. Lower frequencies often work better in the vicinity of metals or liquids. In general, the most suitable tag design depends on the specific application.

RFID tags can be very small which enables a number of different applications. For example, a Hitachi μ-chip can be applied to paper currency to combat counterfeit bills. This is possible because of the small size of the μ-chip, typically being no more than about 0.4 mm² in area and no more than about 0.3 mm in thickness. Some embodiments of a μ-chip transponder measure 0.4 mm² in area and 0.15 mm in thickness. The very small chip can be easily embedded or affixed to a sheet of paper or the like, which typically has a thickness of no more than about 0.5 mm, without altering the general physical characteristics of the sheet, particularly in its thickness. In this way, the sheet containing the RFID chip can still pass through a printer or an optical scanner. A more detailed description of the chip is provided in U.S. Patent Application Publication No. 2006/0077062, the entire disclosure of which is incorporated herein by reference.

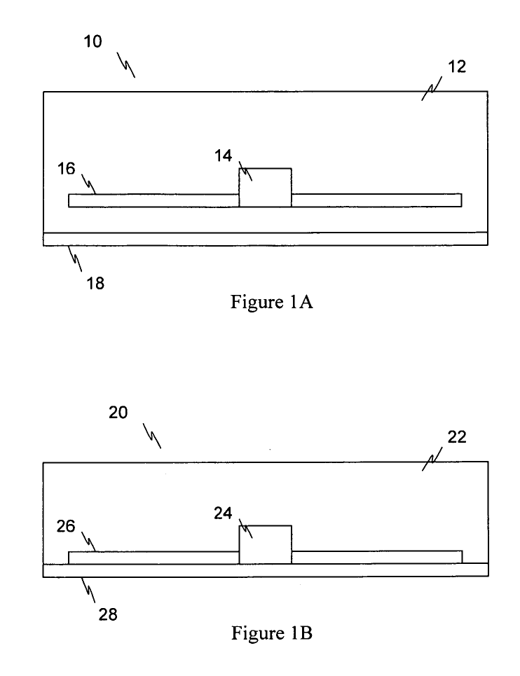

FIG. 1A is a side cross-sectional view of an adhesive member 10 such as a label, seal, or tag having a body 12. Embedded in the body 12 are an RFID chip 14 and an antenna 16. The RFID chip 14 may be a 2.45 GHz RFID micro-chip IC. The antenna 16 may be a detuned linear dipole antenna. An adhesive layer 18 is provided to affix the body 12 to an object with the embedded RFID chip 14. The adhesive member 10 typically has a thickness of about 0.25 mm. The adhesive layer 18 may be formed during fabrication of the adhesive member 10 to provide a self-adhesive member that can be peeled from a sheet and readily applied to an object. Alternatively, an adhesive can be applied to the body 12 when the label is selected to be affixed to an object.

FIG. 1B is a side cross-sectional view of another adhesive member 20 having a body 22, an RFID chip 24, an antenna 26, and an adhesive layer 28. The difference between this adhesive member 20 and the adhesive member 10 of FIG. 1A is that the RFID chip 24 and preferably the antenna 26 are in direct contact with the adhesive layer 28. The adhesive member 20 is constructed with the inlet (the chip 24 attached to the antenna 26) chip-down into the bedding adhesive 28. The RFID chip 24 and antenna 26 are embedded in the structure formed by the body 22 and the adhesive layer 28.

One desirable feature of the adhesive member is that once affixed to an object, it is very difficult to remove. Preferably, it cannot be removed without causing physical damage to the adhesive member, more particularly to the RFID chip, or its interconnect to an external antenna, if an antenna is used, such that the ID will no longer be readable. One way to do so is to select a very strong adhesive. In addition, the body of the adhesive member can be relatively thin and/or made of a relatively weak, easily distorted material. Having direct contact between the RFID chip and the adhesive may increase the likelihood that the chip or its ability to communicate will be destroyed during removal from the object to which it is affixed.

The RFID chip is preferably embedded in the adhesive member which may be an adhesive sticker, label, tag, seal, or the like. The adhesive member containing an RFID chip is very lightweight and can be used to authenticate the article to which the adhesive member is affixed. The adhesive member can be custom printed or commoditized off-the-shelf. Once affixed to the article, the adhesive member is not easily removed. Preferably, the adhesive member cannot be removed from the article without destroying the RFID chip or its ability to communicate.

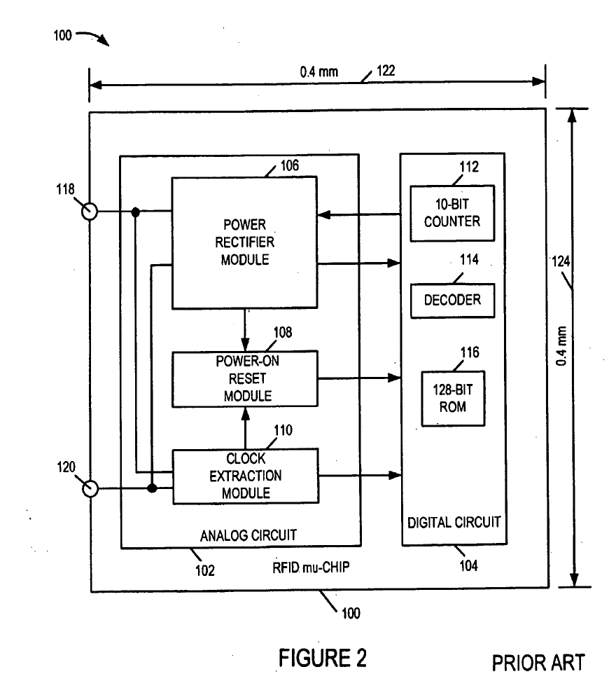

FIG. 2 shows one example of an RFID chip coupled to an antenna. The RFID chip may be a Hitachi μ-chip. Hitachi's μ-chip aids upwards communication from real-world objects to virtual ones. The RFID μ-chip 100, as shown in functional circuit blocks in FIG. 2, is 0.06-mm thick and 0.4-mm long on each side. The RFID μ-chip 100 includes an analog circuit 102 and a digital circuit 104. The analog circuit 102 includes a power rectifier module 106, a power-on reset module 108, and a clock extraction module 110. The digital circuit 104 includes a 10-bit counter 112, a decoder 114, and a 128-bit ROM 116. The analog circuit 102 is coupled to the digital circuit 104. The analog circuit 102 is also coupled to antenna terminals 118 and 120. By applying suitable packaging techniques, manufacturers can embed μ-chips in micro-objects. The 2.45 GHz band frequency, used for radio communication signaling between the μ-chip and a sensor, similar to that used by Bluetooth technology, enables use of a small sensor device.

The current μ-chip function is to return the 128-bit identification data stored in 128 bit ROM 116 upon receiving the radio wave from an external sensor. This data is the same length as IPv6 addresses. The μ-chip's characteristics give it an advantage in certain applications over other approaches to identifying and tracking products. Current μ-chips retain 128-bit ID information in ROM 116, which is written only once at manufacturing time. The 128-bit ID information in ROM 116 cannot be modified after shipment.

The μ-chip is similar to the bar code in that both give identification numbers to objects. One major difference is that μ-chips can be attached to smaller objects than those to which a bar code can be attached, because a bar code has a larger surface area than a μ-chip. Therefore, the μ-chip enables handling of objects efficiently in a wider range of applications than the bar code. Furthermore, copying μ-chips is much more difficult than copying bar codes. Thus, μ-chips can handle objects more securely than bar codes, preventing the forgery of security papers and providing counterfeit protection for branded products.

The use of a read-only RFID chip embedded in a security label or seal that is affixed to an item for protection is tamper-evident and provides a unique number for each item to which it is attached for item validation. This technology can be used to protect against counterfeits and piracy of original items, as well as to authenticate any specified item. It can be used with any item that must be authenticated as an original, such as legal documents, classified materials, medical and pharmaceutical items, and law enforcement evidence, or any item for Internet-based e-commerce wherein one party wishes to authenticate that an item provided by the other part is genuine. In the case of medical items, the authentication seal may need to survive gamma ray sterilization. The RFID chip preferably is gamma ray compatible as well as low cost. One way to render the RFID chip gamma ray compatible is to structurally “hard wire” the unique ID into the chip, as done in the Hitachi the μ-chip. The hardwired code is far less affected by gamma energy. Test has shown that the μ-chip can survive at least 500 kilogray (kGy) of gamma energy exposure with no detectable damage.

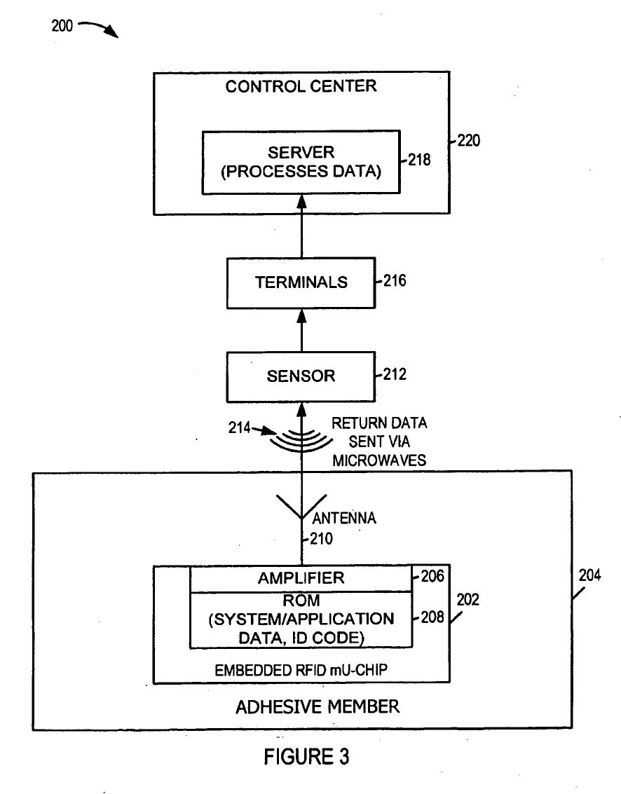

FIG. 3 is a block diagram 200 illustrating an adhesive label or seal embedding an RFID chip/antenna in an article, communicating its ID information to a sensor in an exemplary RFID system. The μ-chip 202 embedded in the adhesive member 204 may be the μ-chip 100 of FIG. 2. The μ-chip 202 includes an amplifier 206 and a ROM 208 including system/application data and an ID code. An antenna 210 is also embedded in the adhesive member 204, and the antenna 210 is coupled to the μ-chip 202.

One counter-measure against piracy or counterfeiting is to embed a μ-chip via adhesive onto security papers or brand name products and verify authenticity with a sensor reading. In this case, a tag reader including a transmitter and a read sensor 212 transmits signals to the μ-chip 202, e.g., using a 2.45 GHz microwave carrier, which is used to power on and activate the μ-chip 202. This causes the μ-chip 202 to transmit its stored 128-bit ID information via the antenna 210. The sensor 212 receives and reads the return data, recovering the 128-bit ID information which has been sent via microwaves 214. With the antenna 210, the μ-chip is readable by the sensor 212 within a 30-cm range, instead of proximate range for reading a μ-chip 202 that is applicable when the antenna 210 is not used. The output from the sensor 212 is sent to the terminal 216. The output from the terminal 216 is then sent to a server 218 which processes the data. The server 218 is part of a control center 220. In both cases, the security audit mechanism implemented in a server 218 checks for any abnormality by analyzing network-transmitted records. The system signals an alarm when it detects an alleged counterfeit chip, identification numbers transmitted at the same time from different locations, or any other predefined abnormality.

One design uses a built-in 100-pf capacitor formed by the gate oxide of the MOS transistor as a power supply, eliminating the need for batteries. The minimum operating voltage of the chip's digital chips is 0.5V. This chip has attached to it a thin-film external antenna. The chip terminals (118, 120) are connected to the antenna by an anisotropic conductive film (ACF). This type of structure results in a 0.15 mm thin transponder. The maximum communication distance between the μ-chip and a reader is expected to be 300 mm at a reader power of 300 mW. The RFID tag includes the μ-chip circuit and antenna. The μ-chip 100 is one example of a RFID circuit, and other types of chip circuits and antennas are also available.

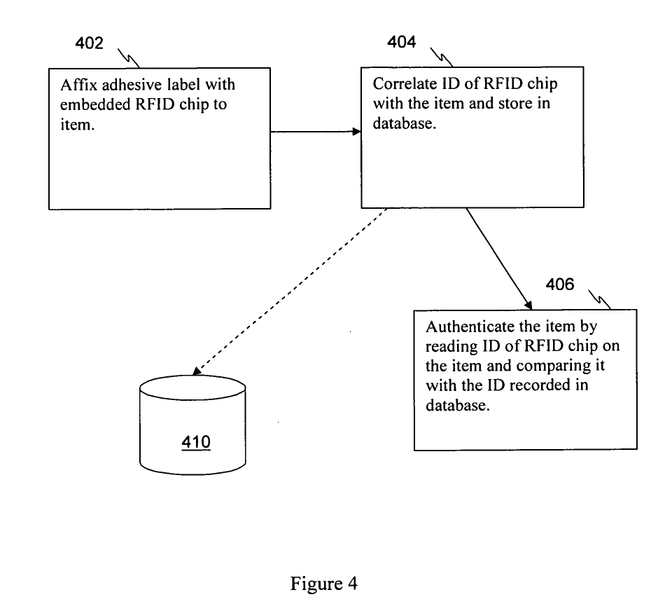

FIG. 4 is a block diagram illustrating an exemplary method of implementing and using an adhesive label having an RFID chip in a system in accordance with an exemplary embodiment of the present invention. In step 402, the adhesive member having an embedded RFID chip is affixed to an item to be authenticated at a future time. This may be done in different ways as described above. The RFID chip contains a unique ID readable by a reader or scanner. In step 404, the unique ID is correlated with the item and stored in a database 410. The database may contain a description of the item. This takes place at a first point in time. At a second point in time later than the first point in time, the item is authenticated in step 406 by reading the ID of the chip on the item and comparing the ID with the ID stored in the database. Typically, the initial reading and/or recording of the ID at the first point in time and the subsequent reading of the ID at the second point in time will take place at different locations.

Step 404 may include scanning or capturing information, automated correlation of information, and/or manual entry of information. For example, a database may already exist, e.g., based on bar codes on a container or protective carrier, correlating each item with a set of information associated with the item such as a title, a description, or the like. An operator may check that the title or description on the item matches the title or description on the container or protective carrier, and then scan the bar code on the container or protective carrier, accessing the set of information associated with the item. This accessed information may be forwarded to the database 410 to be linked with the RFID tag information in step 404. Unlike the container or protective carrier which can be easily separated from the item, the RFID chip will be affixed to the item and is not easily removed, preferably not removable without destroying the RFID chip. Alternately or additionally, an operator can manually enter information pertaining to the item and/or scan information relating to the item, to be included in database 410 and to be linked to information received from step 404. This process creates a record in the database 410 for each item, which may be accessed in the future based on an RFID read.

As an alternative to storing the information correlating the ID of the RFID chip with the item in the database 410, a local ID validation approach may be used. This is accomplished by applying an algorithm to the ID contained in the chip and then printing the algorithmic result on the security seal or label. The algorithm result will be different from the ID in the chip. To authenticate the item, the reader device will apply the algorithm to the ID as it is read from the seal or label and display the algorithmic result on a screen or some other display. The displayed result must match the printed result on the security seal or label for authentication. No database is required for this form of local validation. Yet another alternative form of validation is to print the ID contained in the RFID chip on the security seal or label without applying an algorithm. The security seal or label is validated if the ID printed on it matches the ID read from the chip and displayed using the reader device.

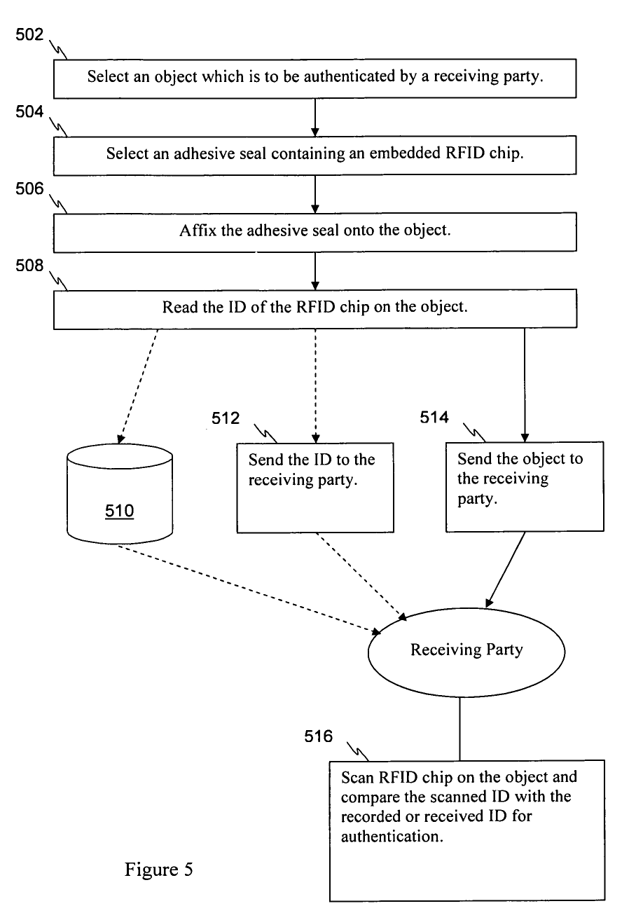

The authentication method can be implemented in a number of scenarios. FIG. 5 shows one scenario involves sending an object from location A to location B, and authenticating that which arrives at location B is the same object that was sent from location A. In step 502, an object is selected which is to be authenticated by a receiving party. The object may be a piece of art, a legal document, an item of sports memorabilia, or the like. In step 504, an adhesive seal is selected from a sheet of adhesive seals provided on a release liner. Each seal contains an embedded RFID chip. In step 506, the adhesive seal is placed on the object to affix or embed the RFID chip onto the object such that the RFID chip is not easily removed, and preferably cannot be removed without destroying the RFID chip or its ability to communicate. Using an RFID reader, the adhesive seal is scanned to read the unique ID of the RFID chip in step 508, and the ID is recorded in an electronic database 510, or printed on the adhesive seal with or without applying an algorithm, for future reference and validation. Alternatively or additionally, the ID is transmitted to the receiving party to whom the object is to be sent in step 512. This can be done by electronic mail, postal mail, or other suitable means. In step 514, the sending party sends the object to the receiving party via a different path or route. This can be done by courier, mail, or the like. At the receiving party's location, in step 516, the receiving party scans the RFID chip on the object to read the ID in the chip and compares it with the previously recorded ID that the receiving party obtains by accessing the electronic database containing the recorded ID or was printed on the adhesive seal with or without applying an algorithm, or that the receiving party receives from the sending party. The comparison can be done manually or electronically. If the two IDs match, the object is authenticated.

This scenario can become a standard procedure for authenticating items such as classified documents, legal documents, or e-commerce objects in general where the two parties to a transaction (buyer and seller, or sender and receiver) may not know or trust one another, and need a reliable and efficient way of ensuring the integrity of the object of the e-commerce transaction.

Another scenario involves the authentication of an object among multiple stakeholders. For example, highly prized art pieces or sports memorabilia require painstaking efforts to authenticate to ensure that an item of interest is what it is claimed to be, such as an original painting by a famous artist or a signature or an autograph of a sports celebrity. Once an item is sold, perhaps years later, it is not uncommon for a new owner to want to re-authenticate the item. In this case, the use of the adhesive seal with an embedded RFID chip on the item that was authenticated years earlier by an expert could save the time and expense of manual re-authentication. Instead, the earlier authentication of the item can be confirmed inexpensively and efficiently without manual re-authentication.

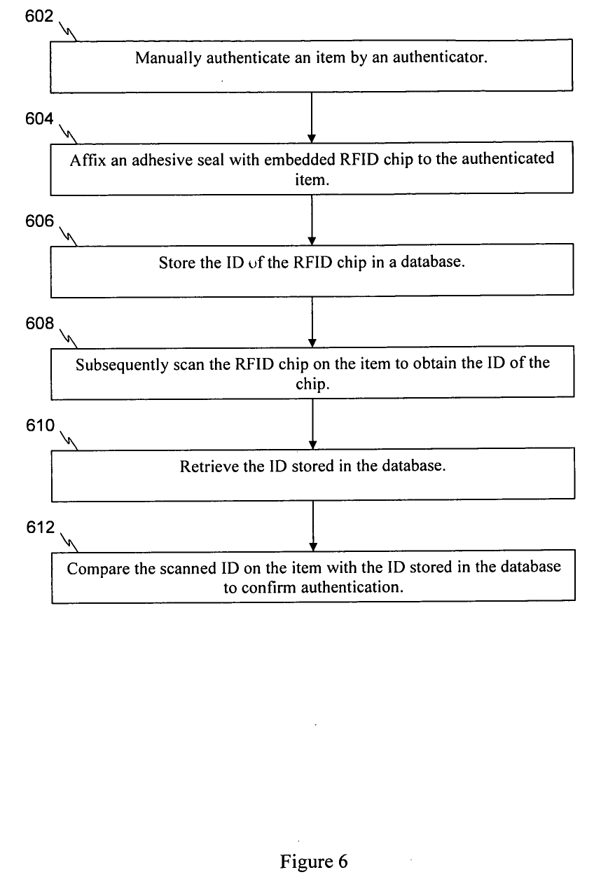

As shown in FIG. 6, the item was originally authenticated manually by an authenticator in step 602. The authenticator is an expert or some other authority that is specifically qualified to authenticate the item at issue and is preferably legally recognized or approved. The authenticator can be the originator of the item such as an artist who created the painting or a celebrity who autographed a piece of memorabilia. An adhesive seal with an embedded RFID chip is affixed to the authenticated item in step 604. The unique ID in the RFID chip is recorded in a database in step 606. Alternatively, the unique ID is printed on the adhesive seal for local validation with or without applying an algorithm. At a later time, perhaps years later, the authentication of the item can be confirmed, typically by a different owner. In step 608, the item is scanned to capture the ID in the RFID chip affixed to the item. In step 610, the recorded ID which is correlated with the item in question is retrieved from the database or was printed on the adhesive seal with or without applying an algorithm. This can be done manually or electronically. In step 612, the two IDs are compared to confirm that the item is the same item that was manually authenticated previously. One advantage of this method is that neither the original owner nor the originator authenticator would need to be involved. The savings could be significant. The average effort to authenticate a painting or an autograph costs between $200 and $500 per item. The use of the adhesive seal with an embedded RFID chip affixed to the item for later confirmation of the manual authentication can significantly save time and reduce cost.

In another scenario, the adhesive label with an embedded RFID chip is used to track an object over time to preserve authenticity. This is particularly advantageous for tracking an object that is located among other similarly looking objects. An example is the tracking of specimen slides that are produced and stored, and then revisited days, weeks, or years later. The adhesive label can be placed on a specimen slide or vial or some other container, and it can be scanned and recorded into a database binding that specimen item to the scanned ID, and with the ID, all the field descriptors that are part of the record. At a later time, the lab technician will be able to reselect the specimen, scan it to obtain its unique ID, and using that unique ID, access the record associated with that specimen. This tracking scheme will significantly limit human error in mistaking one specimen for another, and substantially speed up the specimen verification process.

Still another scenario is a chain of custody situation that involves, for example, law enforcement evidence or other legal evidence. In this case, the item must pass through custody of multiple individuals who will have control of the item at different points in time. The use of the adhesive seal with a very small RFID chip on the item of evidence is advantageous, since various items of evidence can differ significantly in size, texture, shape, and composition. This scheme of preserving authenticity of an item through a chain of custody provides a much more efficient solution, ensures heightened security, and promotes better authentication for irrefutable chain of custody and item control than the current “tag on a string” solution used today.

In addition, the authentication method of the present invention can be used for a variety of applications including the following: to authenticate classified documents (e.g., U.S. Federal Government), to verify legal documents including bank notes, to authenticate works of art by the artist himself or a third party authenticator, to verify genuine or specific items in e-commerce transactions, to identify assets and to track high-value, mobile items, to support self-service issuance and return of equipment within an enterprise, to place on personal items and use the UID to support a loyalty program, to place on objects requiring calibration for quality control applications, to attach to an existing employee badge for access control without the requirement for badge re-issuance, to support product warranties on major end items, to use in security functions to specify protective measures or determine handling restrictions, to authenticate sports memorabilia, to verify critical system parts, and to authenticate blood, tissue and other life sciences specimens and medical disposables that must endure gamma ray sterilization protocols.

All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

While specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the above description has been made in an illustrative fashion, and not a restrictive one. Accordingly, the scope of the invention should properly be determined with reference to the appended claims, along with the full range of equivalents to which such claims are entitled.

What is claimed is:

1. An authentication method comprising:
providing an RFID chip having a unique ID readable by a device;
applying the chip to an item via an adhesive;
associating the ID of the chip with the item and storing the associated ID at a first point in time; and
at a second point in time later than the first point in time, authenticating the item by reading the ID of the chip applied to the item and comparing with the ID associated with the item at the first point in time.

2. The authentication method according to claim 1, wherein the ID of the chip is correlated with a description of the item and stored in a database separate from the item and from the RFID chip.

3. The authentication method according to claim 1, wherein the RFID chip is embedded in a label, and wherein the ID is printed on the label.

4. The authentication method according to claim 1, wherein the RFID chip is embedded in a label, wherein an algorithm is applied to the ID of the chip to produce an algorithm result and the algorithm result is printed on the label at the first point in time, and wherein authenticating the item includes reading the ID of the chip applied to the item, applying the algorithm to the read ID, and comparing with the algorithm result printed on the label at the first point in time.

5. The authentication method according to claim 1, wherein the chip is a read-only chip whose ID cannot be altered after manufacture.

6. The authentication method according to claim 1, wherein the chip is a semiconductor chip compatible with gamma ray energy.

7. The authentication method according to claim 1, wherein the ID is only readable by the device.

8. The authentication method according to claim 1, wherein applying the chip to the item comprises applying to the item an adhesive label with the chip embedded in the adhesive label.

9. The authentication method according to claim 8, wherein removing the adhesive label from the item destroys the chip or its ability to communicate.

10. The authentication method according to claim 1, wherein the item is a container including a specimen.

11. The authentication method according to claim 1, wherein the chip is a semiconductor chip having an area of no more than about 0.4 mm² and a thickness of no more than about 0.3 mm.

12. The authentication method according to claim 1, further comprising, at or near the first point in time and prior to the second point in time, manually authenticating the item by an authenticator qualified to authenticate the item.

13. The authentication method according to claim 1, further comprising, between the first point in time and the second point in time, passing the item through a chain of custody among at least three parties.

14. An authentication method for a document comprising:
providing an RFID chip having a unique ID readable by a device;
embedding the chip onto the document by an adhesive seal;
transmitting the ID via a first path to a location different from where the embedding was processed;
sending the document with the embedded chip to the location via a second path different from the first path; and
authenticating the document by reading the ID of the chip embedded onto the document and comparing with the ID transmitted via the first path.

15. The authentication method according to claim 14,
wherein the document is a sheet of paper; and
wherein the ID is transmitted via electronic mail.

16. The authentication method according to claim 14, wherein the ID is written into the chip during formation of the chip in a semiconductor manufacturing process.

17. The authentication method according to claim 14, wherein the chip is a read-only chip whose ID cannot be altered after manufacture.

18. The authentication method according to claim 14, wherein the chip is a semiconductor chip that is at most about 0.4 mm in size.

19. The authentication method according to claim 14, wherein the chip is a semiconductor chip having a thickness of at most about 0.3 mm.

20. An authentication method comprising:
providing an RFID chip having a unique ID readable by a device;
affixing the chip to an article via an adhesive in such a manner that the chip cannot be removed from the article without rendering the ID of the RFID chip unreadable;
associating the ID of the chip with the article; and
subsequent to the associating, authenticating the article by reading the ID of the chip applied to the article and comparing with the ID associated with the article.

21. The authentication method according to claim 20, wherein the chip is embedded in an adhesive member which is affixed to the article via an adhesive.

22. The authentication method according to claim 20, wherein affixing the chip to the article comprises placing an adhesive layer in direct contact with the RFID chip on one side of the adhesive layer and in direct contact with the article on an opposite side of the adhesive layer.

23. The authentication method according to claim 20, wherein the ID of the chip is correlated with a description of the article and stored in a database separate from the article and from the RFID chip.

24. The authentication method according to claim 20, wherein the RFID chip is embedded in a label, wherein associating the ID of the chip with the article comprises applying an algorithm to the ID of the chip to produce an algorithm result and printing the algorithm result on the label, and wherein authenticating the article includes reading the ID of the chip affixed to the article applying the algorithm to the read ID, and comparing with the algorithm result printed on the label.

25. The authentication method according to claim 20, wherein the chip is a semiconductor chip having an area of no more than about 0.4 mm² and a thickness of no more than about 0.3 mm, and wherein the article has a thickness of no more than about 0.5 mm.
